(19) United States
(12) Patent Application Publication
(10) Pub. No.: US 2007/0136301 A1
(43) Pub. Date: Jun. 14, 2007

(54) Systems and methods for enforcing protocol in a network using natural language messaging

(75) Inventor: Cary Anthony Jardin, Poway, CA (US)

Correspondence Address: BAKER & MCKENZIE LLP;PATENT DEPARTMENT, 2001 ROSS AVENUE, SUITE 2300, DALLAS, TX, 75201, US

(73) Assignee: IP3 Networks

(21) Appl. No.: 11/299,567

(22) Filed: Dec. 12, 2005

(51) Int. Cl. G06F 17/30

(52) U.S. Cl. 707/10

(57) ABSTRACT

A network access device is configured to receive requests for network resources from a client device, generate a natural language message regarding the request, and forward the natural language message to a network administrator using a communication program such as an email program, Instant Massaging (IM) program, or a Short Messaging Service (SMS) program. The network administrator can then respond to the message by generating and sending a natural language message to the network access device. The network access device can then parse the natural language response in order to determine what action to take.

### BACKGROUND

1. Field of the Invention

The embodiments described below generally relate to network communications, and more particularly to the provisioning and administration of network services within an enterprise network.

2. Background of the Invention

Network access, and the administration of network access has become increasingly important in the enterprise environment. Even a modest-sized enterprise can comprise multiple internal networks and can have multiple interfaces with external networks such as the Internet. Further, an enterprise network can comprise multiple services available to the users within the enterprise. Some of these services can be global services, while others can be restricted services.

Enterprise network administrators are responsible for provisioning access to the networks and services within the enterprise network. Consequently, the network administrator must configure each user's device and user profile within the network in order to allow the appropriate access to the networks and services available. Further, the administrator is responsible for security such as the provisioning and configuration of firewalls, passwords, filters, etc.

Provisioning and administration of user capabilities is essentially a manual process in today's environment. In other words, the administrator must go in on a user-by-user basis and administer and configure the user's capabilities. This more or less manual process is inefficient, time consuming and costly.

### SUMMARY

A network access device is configured to receive requests for network resources from a client device, generate a natural language message regarding the request, and forward the natural language message to a network administrator using a communication program such as an email program, Instant Massaging (IM) program, or a Short Messaging Service (SMS) program. The network administrator can then respond to the message by generating and sending a natural language message to the network access device. The network access device can then parse the natural language response in order to determine what action to take.

In one aspect, the network access device can engage in a natural language dialogue with the network administrator in order to provide the administrator with the requisite information and to determine what action is appropriate.

In another aspect, the network access device can include artificial intelligence that allows the network access device to learn from the dialogue with the network administrator.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIG. 1 is a diagram illustrating an enterprise network configured in accordance with one embodiment;

FIG. 2 is a flowchart illustrating an example method for provisioning services and resources within the network of FIG. 1 in accordance with one embodiment;

FIG. 3 is a flowchart illustrating another example method for provisioning services and resources within the network of FIG. 1 in accordance with another embodiment;

FIG. 4 is a flowchart illustrating the administration of network services and resources using natural language messaging in accordance with one embodiment; and

FIG. 5 is a diagram illustrating an example network access device configured in accordance with one embodiment.

### DETAILED DESCRIPTION OF THE PREFERRED EMBODIMENTS

In the systems and methods described below, certain network configurations and architectures are described; however, it will be understood that the systems and methods described herein are not limited to any particular network configuration or architecture. As such, the systems and methods described herein should not be seen as being limited to any particular configurations or architectures.

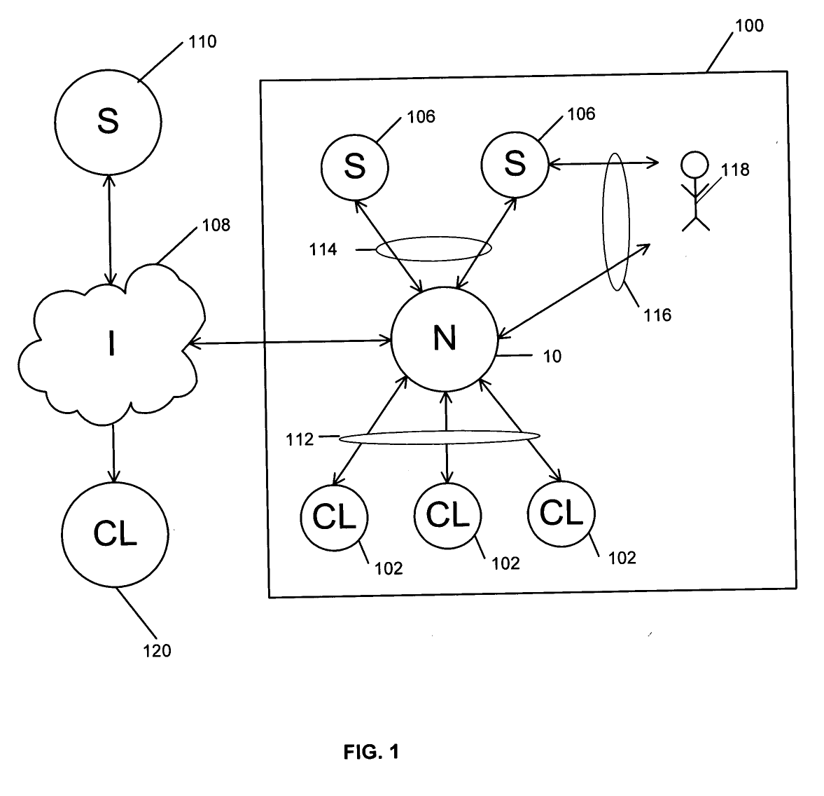

FIG. 1 is a diagram illustrating an enterprise network 100 configured in accordance with one embodiment of the systems and methods described herein. Enterprise network 100 comprises a plurality of client devices 102 interfaced with a network access device 104. Network access device 104 is configured to control access by client devices 102 to servers 106, which are configured to provide services and resources to client devices 102.

Client devices 102 communicate with network access device 104 via communication links 112. Communication links 112 can comprise wired or wireless network connections. Typically these network connections are referred to as Local Area Network (LAN) communication links, and enterprise network 100 is often referred to as a LAN; however, communication links 112 can also comprise wired or wireless Personal Area Network (PAN) communication links, or other local communication links.

Network access device 104 is in turn interfaced with service 106 via communication links 114. Communication links 114 can also comprise wired or wireless LAN or PAN communication links.

In certain embodiments, one or more network administrators 118 can access servers 106 and/or network access device 104 via communication links 116. The network administrator can administer the provisioning of services and resources to client devices 102. Conventionally, network administrator 118 would provision the services and resources by creating a user profile for each client device 102. The user profile can include the capabilities and heuristic data associated with a user's client device 102, as well as any passwords, restrictions, etc. Any changes in the provisioning of services and resources would require network administrator 118 to access the appropriate user profile and make the required changes.

Network administrator 118 can access servers 106 and/or network access device 104 using a client device 102. Client devices 102 can comprise desktop or laptop computers, or other portable computing devices, such as palm computers, Personal Digital Assistants (PDAs), etc. Such portable computing devices can even comprise devices more commonly associated with personal communications such as cellular telephones, Blackberrys, smart phones, etc.

Network access device 104 can comprise a gateway, firewall, switch, wireless access point, server, or some combination thereof. In other words, network access device 104 can comprise any device configured to allow access to network based communications.

As illustrated, network access device 104 can also be configured to interface client devices 102 with an external network 108 such as the Internet. In certain embodiments, network access device 104 can manage the provisioning of services or resources from an external server 110 through network 108. Further, in certain embodiments, network access device 104 can be configured to manage access to servers 106 by remote client devices 120 via network 108. Provisioning of services to remote client devices 120, as well as access to remote server 110, can be achieved in a manner similar to that used for servers 106 and client devices 102 within network 100. It will be understood, however, that additional procedures may need to be implemented in order to authenticate, validate, etc. remote client devices 120 and to protect against the provisioning of malicious applications from external servers 110.

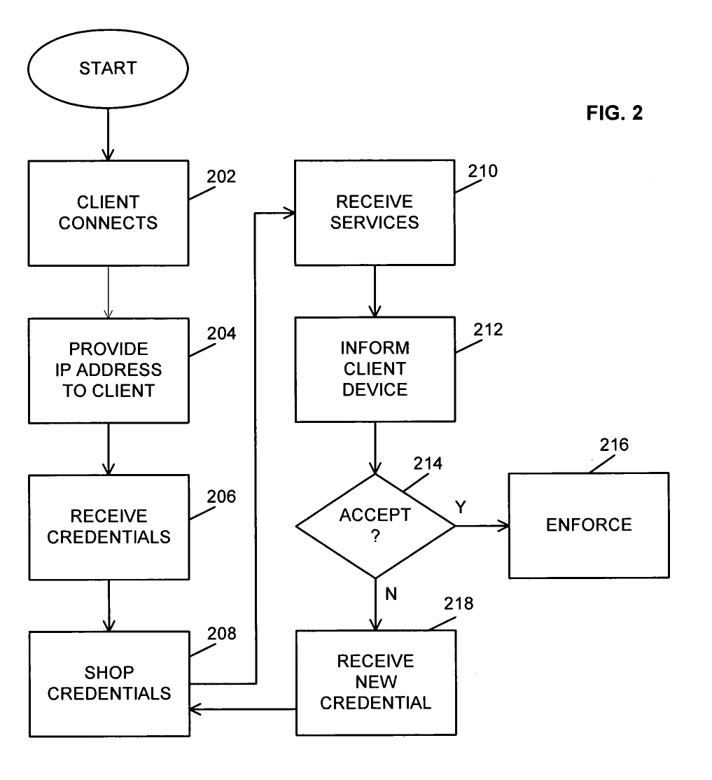

FIG. 2 is a diagram illustrating an example method for the provisioning of services and resources from servers 106 to client devices 102. In network 100, network access device 104 acts as a go between to enable client devices 102 and servers 106 to negotiate what services and resources will be made available to client devices 102. Thus, the negotiation of what services and resources will be made available can be referred to as a three-way handshake between client devices 102, network access device 104, and servers 106. Once the services and resources to be made available are agreed upon, network access device 104 can be configured to enforce the provisioning of the services and resources.

Thus, in step 202, a client device 102 can attempt to connect with network 100 through network access device 104. In step 204, network access device 104 can be configured to provide the client device 102 with an IP address so that client device 102 can be identified on the network. In step 206, network access device 104 can receive credentials associated with client device 102 from client device 102.

The credentials received in step 206 can comprise information identifying client device 102, as well as information identifying the capabilities of the client device, such as the processing speed, memory size, communication capabilities, etc. In general, the credentials provided by client device 102 in step 206 include heuristic data associated with client device 102 that can be used to determine what network resources and services are available to client device 102.

In step 208, network access device 104 can “shop” the credentials received in step 206 to servers 106. In other words, network access device 104 can forward the credentials received in step 206 to servers 106 so that servers 106 can make a determination as to what services and resources will be made available to client device 102 based on the credentials received from network access device 104 in step 208.

In step 210, network access device 104 can receive from servers 106 the available services and resources. In step 212, network access device 104 can inform client device 102 of the available services and resources. In step 214, network access device 104 can receive, from client device 102, an indication as to whether client device 102 will accept the services and resources made available from servers 106.

If client device 102 indicates that it will accept the services and resources in step 214, then in step 216 network access device 104 can enforce the provisioning of the services and resources made available in step 210 and accepted it in step 214. In other words, network access device 104 can be responsible for controlling to what services and resources client devices 102 have access.

If in step 214 client device 102 indicates that it will not accept the services and resources made available, then in step 218 client device 102 can provide new credentials to network access device 104. In other words, client device 102 can change its credentials, such as the memory or communications capabilities that it will make available in order to use the services and resources within network 100. Network access device 104 can be configured to then shop the new credentials in step 208 and the process will repeat from that.

Thus, unlike conventional networks, network 100 uses a three-way handshake to establish what services and resources will be made available to client device 102. Further, unlike conventional networks, network access device 104 is responsible for controlling what services and resources client devices 102 has access to based on the services and resources that have been made available and have been agreed upon.

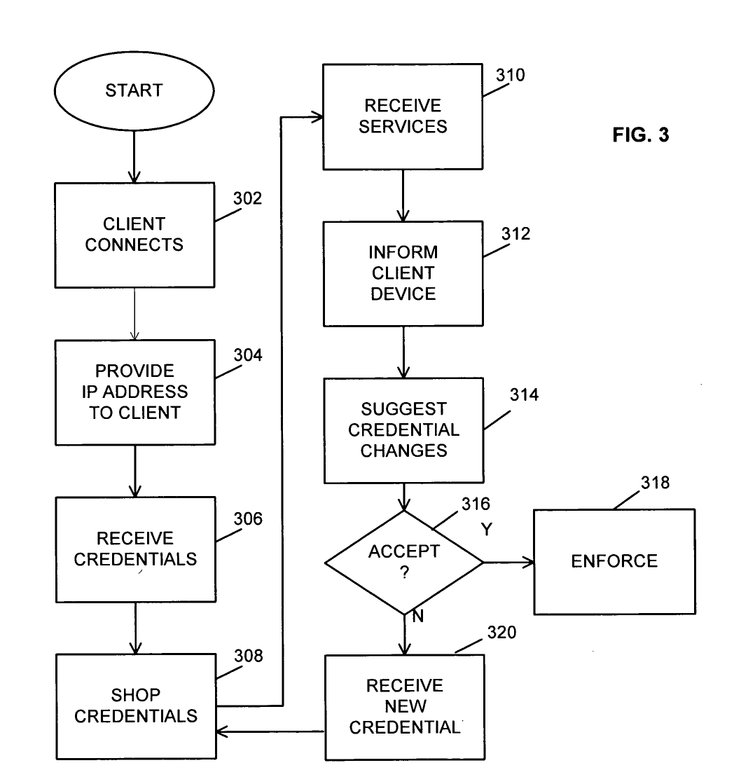

FIG. 3 is a flowchart illustrating another example method for provisioning services and resources within network 100 in accordance with one embodiment of the systems and methods described herein. As with the method of FIG. 2, a client device 102 can attempt to connect with the network access device 104 in step 302. In step 304, network access device 104 will provide an IP address to client device 102. In step 306, network access device 104 will receive credentials associated with client device 102. In step 308, network access device 104 will shop the credentials to servers 106, and received the available services and resources in step 310. In step 312, network access device 104 will inform client device 102 of the services and resources made available.

Unlike the process of FIG. 2, in step 314, network access device 104 can suggest modifications, upgrades, changes, etc., to the credentials provided in step 306 that would make available further, or more advanced services and resources.

In step 314, the client device can again indicate whether or not it will accept the services and resources made available. If client device 102 accepts the services and resources in step 314, then in step 316 network access device 104 will enforce the services and resources made available.

If client device 102 rejects the services and resources made available in step 312, then client device 102 can provide new credentials in step 318. The credentials provide in 318 can, however, be based on the suggestions made in step 314. Network access device 104 can be configured to receive any credentials in step 318 and shop them to servers 106 in step 308 at which point the process will repeat.

While the systems and methods described in relation to FIGS. 1-3 can take some of the burden off of the network administrator with regard to administering network access and user profiles by allowing the users client device 102 to negotiate with servers 106 through network access device 104 as to what services and resources will be made available and by allowing the users client device 102 to modify its credentials as needed or desired, the network administrator still must manually establish user profiles for such things as access to certain services and resources.

In certain embodiments, however, network access device 104 can comprise Artificial Intelligence (AI), such as neural network capabilities. The AI capabilties can provide network access device 104 with natural language messaging and processing capabilities. This natural language messaging and processing capability can be used to reduce the burden on the network administrator in administering access and restrictions to system services and resources by allowing the network administrator to communicate with network access device 104 using Natural Language Messaging (NLM).

For example, when a client device attempts to access, or requests a certain network service or resource, network access device 104 can be configured to process/parse the request and generate an natural language message that can be sent to network administrator 118 using one or more communication applications. In other words, if network access device 104 is configured to communicate with network administrator 118 using email, then network access device 104 can be configured to process the client device request and generate an email message to network administrator 118 indicating, in natural language, the nature of request generated by client device 102. Network administrator 118 can then respond, e.g., via email with a natural language message directing network access device 104 to take one or more actions.

When network access device 104 receives the natural language message from network administrator 118, network access device 104 can be configured to again process/parse the natural language message contained in the email and determine what actions it is required to take.

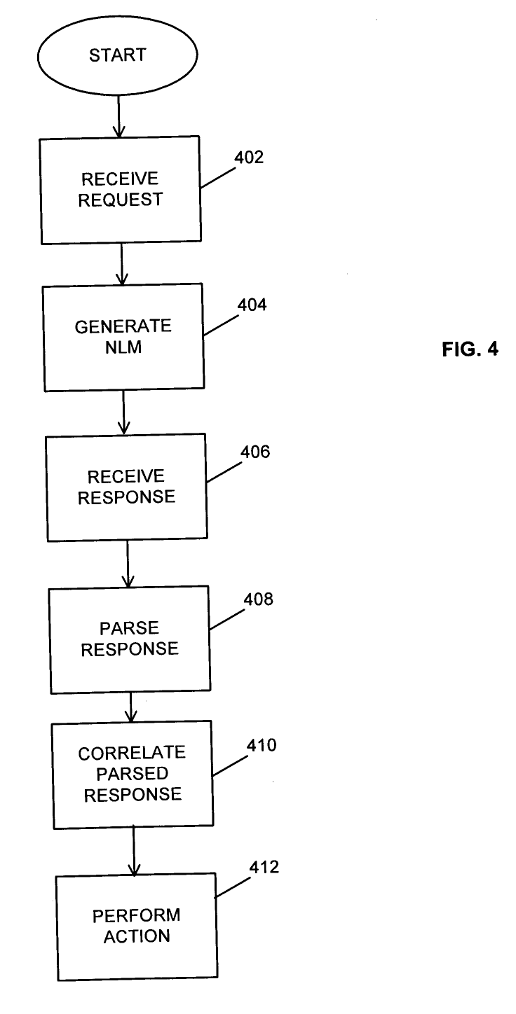

FIG. 4 is a flowchart illustrating one example method for administering policy through a network access device 104 using natural language messaging capabilities such as described above. First, in step 402, network access device 104 can receive a request from a client device 102 for a network resource. In step 404, network access device 104 can create a natural language message and send it to administrator 118 using a standard communication program such as email, Instant Messaging (IM), Short Message Service (SMS), etc. In step 406, administrator 118 can respond to the natural language message sent in step 404 as if administrator 118 was talking to another person as opposed to network access device 104.

For example, in step 404 network access device 404 can create a message for administrator 118 that says “Bob” wants to access resource A. This message can then be sent, e.g., in an email or IM message, to administrator 118. Administrator 118 can then type an email or IM response, e.g., with a question such as “for how long does Bob want an access to resource A,” or an instruction, such as “grant bob access for today only.”

In step 408, network access device 104 will receive the response, process/parsed the response using the natural language processor included therein, and correlate the parsed response, in step 410, with instructions to be carried out by network access device 104. In step 412, network access device 104 will carry out the instructions correlated with the response received in step 406.

In certain embodiments, network access device 104 can be configured to carry on a natural language dialogue with administrator 118 in order to setup and enforce network protocols. In other words, when network access device 104 receives a message in step 406 such as the one above, asking for how long does Bob want access to resource A, network access device 104 can determine from parsing the message that a response is required. Network access device 104 can then respond to the message received from administrator 118 with an appropriate reply. This may require network access device to acquire further information from client device 102 or server 106. In this manner, administrator 118 can administer network protocol within network 100 in a more natural, automated fashion as opposed to accessing the user profiles and permissions within network 100 in order to change them manually.

Network access device 104 can even be configured to recognize responses and commands and act on them independently at least to some degree. Network access device 104 can learn from its interactions, e.g., learn what questions to ask, what responses to expect, and what instructions to carry out.

In certain embodiments, network access device 104 can be configured to communicate with client device 102 using natural language message dialogues in a manner similar to that described with relation to administrator 118. Again, network access device 104 can be configured to learn from the dialogues it has with client device 102, or the user thereof.

Thus, network access device can act as an intelligent go between to negotiate and enforce the availability of services and resources within network 100 and for establishing and enforcing protocols associated with the provisioning of those services and resources.

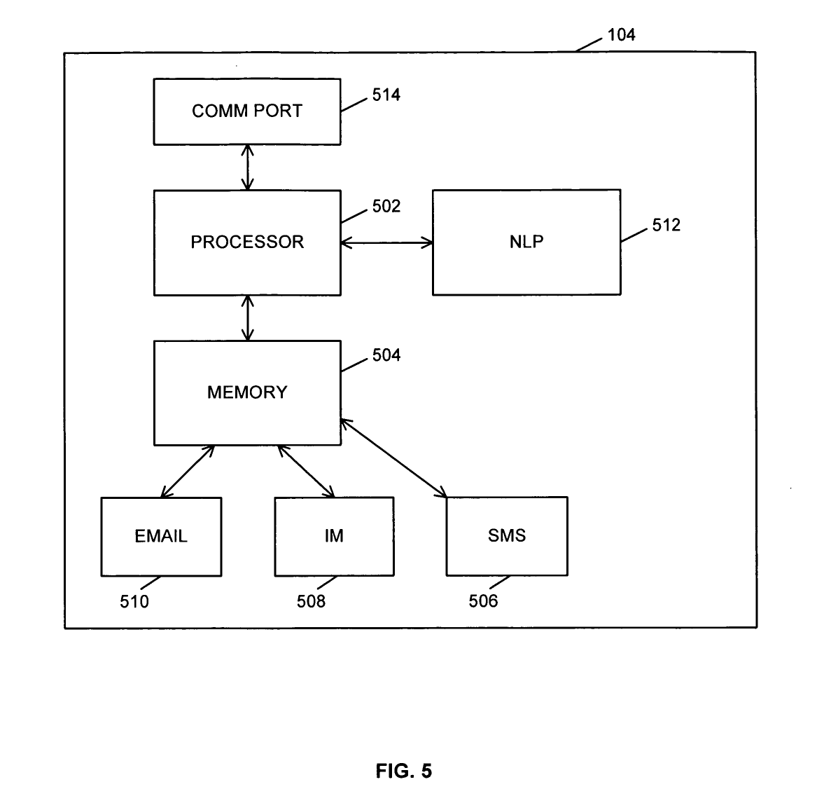

FIG. 5 is a diagram illustrating one example embodiment of a network access device 104 configured in accordance with the systems and methods described herein. As can be seen, network access device 104 can comprise a processor 502 and memory 504. Memory 504 can be configured to store the instructions and data required for the operation of network access device 104. In operation, processor 502 can access the instructions and data stored in memory 504 in order to execute those instructions as required to control the operation of network access device 104.

Processor 502 can comprise one or more processors or processing circuits, such as digital signal processors, math coprocessors, communication processors, controllers, etc. Processor 502 can be a single device or multiple devices. Where processor 502 comprises multiple devices, these multiple devices can be included in a single package, or multiple packages.

Memory 504 can comprise both the permanent memory needed to store instructions and permanent data as well as temporary memory required to store temporary variables and information. Thus, memory 504 can comprise one or more flash memories, electrically erasable programmable read-only memories, dynamic random access memories, electrically programmable read-only memories, static random access memories, etc. Memories included in memory 504 can be included in a single package or multiple packages depending on the embodiment.

Network access device 104 can also comprise one or more communication ports 514 through which network access device 104 can communicate with client devices 102, servers 106, external networks 108, and network administrators 118.

Memory 504 can be configured to store one or more communications applications such as an SMS application 506, IM application 508, or email application 510. Processor 502 can be configured to access such communications applications in order to communicate with other entities via communication port 514.

In addition, network access device 104 can comprise a natural language processor 512. It will be understood that natural language processor 512 can comprise hardware, software, or some combination thereoff. Hardware components of natural language processor 512 can be included within processor 502, or can be included as a separate component as illustrated in FIG. 5. The software components of natural language processor 512 can be stored in memory 504 or in another memory included in network access device 104.

Natural language processor 512 can be configured to process/parse natural language messages received via communication port 514 and generate natural language message responses, or correlate the information in the natural language messages received via communication port 514 to instructions stored in memory 504.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

What is claimed:

1. In a network comprising a plurality of client devices, a plurality of servers configured to make services and resources available to the plurality of client devices, and a network access device configured to interface the plurality of client devices with the plurality of servers, a method for providing the services and resources to the client devices, comprising the network access device:
receiving a request for a network resource from one of the plurality of client devices;
parsing the received request;
generating a natural language message based on the parsed request; and
sending the natural language message to a network administrator using a communication program.

2. The method of claim 1, further comprising receiving a natural language response from the network administrator and parsing the natural language response to determine what action to take next.

3. The method of claim 2, further comprising correlating at least part of the parse natural language response with an instruction to carry out concerning the provisioning of the requested network resource to the client device.

4. The method of claim 3, further comprising generating another natural language message in response to the received response and sending the natural language response message to the network administrator using the communication program.

5. The method of claim 4, further comprising receiving further information from the client device, and generating the natural language response message based on the further received information.

6. The method of claim 5, further comprising learning from the natural language dialogue with the network administrator what messages to generate in response to certain requests or responses.

7. The method of claim 5, further comprising learning from the natural language dialogue with the network administrator what instructions to perform in response to certain requests or responses.

8. The method of claim 5, further comprising learning from the natural language dialogue with the network administrator what further information to obtain in response to certain requests or responses.

9. The method of claim 1, wherein the communication program is an email program, and wherein sending the natural language message to the administrator comprises embedding the natural language response into the body of an email and sending the email using the email program.

10. The method of claim 1, wherein the communication program is an instant messaging program, and wherein sending the natural language message to the administrator comprises embedding the natural language response into the body of an instant message and sending the instant message using the instant message program

11. The method of claim 1, wherein the communication program is a short messaging service program, and wherein sending the natural language message to the administrator comprises embedding the natural language response into the body of a short message service message and sending the short message service message using the short message service program.

12. A network access device, comprising:
a communication port configured to enable the network access device to communicate with a plurality of client devices and a network administrator;
a communication program configured to generate and receive messages; and
a natural language processor configured to take a request received from one of the plurality of client devices, parse the request, and generate a natural language message based on the parsed request to be communicated to the network administrator using the communication program.

13. The network access device of claim 12, wherein the communication program is an email program.

14. The network access device of claim 12, wherein the communication program is an instant messaging program.

15. The network access device of claim 12, wherein the communication program is a short messaging service program.

16. The network access device of claim 12, wherein the network access device is configured to engage in a natural language dialogue with the network administrator.

17. The network access device of claim 12, wherein the natural language processor is configured to receive a natural language response from the network administrator via the communication port, parse the response and correlate at least part of the response with an instruction to be carried out by the network access device.

18. The network access device of claim 12, wherein the natural language processor is configured to receive a natural language response from the network administrator via the communication port, parse the response and generate a natural language message to be sent to the network administrator using the communication program based at least in part on the parsed response.

19. The network access device of claim 16, further comprising a neural network, the neural network configured to learn from the natural language dialogue with the network administrator what messages to generate in response to certain requests or responses.

20. The network access device of claim 16, further comprising a neural network, the neural network configured to learn from the natural language dialogue with the network administrator what instructions to perform in response to certain requests or responses.

21. The network access device of claim 16, further comprising a neural network, the neural network configured to learn from the natural language dialogue with the network administrator what further information to obtain in response to certain requests or responses.
